(19) United States
(12) Patent Application Publication
(10) Pub. No.: US 2006/0265571 A1
(43) Pub. Date: Nov. 23, 2006

(54) Processor with different types of control units for jointly used resources

(76) Inventors: Thomas Bosch, Ponte Tresa (CH); Markus Thalmann, Zulrich (CH); Matthias Tramm, Wildberg (CH)

Correspondence Address: WELSH & KATZ, LTD, 120 S RIVERSIDE PLAZA, 22ND FLOOR, CHICAGO, IL, 60606, US

(21) Appl. No.: 10/547,560

(22) PCT Filed: Mar. 1, 2004
(86) PCT No.: PCT/CH04/00106

§ 371 Date: Jun. 19, 2006

(30) Foreign Application Priority Data
Mar. 5, 2003 (CH) 342/03

(51) Int. Cl. G06F 9/30

(52) U.S. Cl. 712/200

(57) ABSTRACT

The invention relates to a processor comprising several control units and functional blocks which can be commonly accessed by the control units. The processor also includes a central control unit which determines the access of the control units to the functional blocks. At least two control units are embodied as control units of a different type.

### FIELD OF THE INVENTION

The invention relates to a processor having a plurality of control units.

### BACKGROUND

The now great prevalence of multimedia appliances, such as audio video recorders, digital cameras, DVD players etc., requires communication networks which operate in real time. In order to be able to receive and transfer data from multimedia applications, large-scale integrated system circuits on one chip are required, otherwise such multimedia applications would not be possible in the private sector on account of cost or space requirement.

In this case, it should be considered that tasks which are typical of such multimedia applications, such as encryption/description, compression/decompression, signal processing, filtering or transport formatting (framing), place very high demands on processing power. While signal processing objectives are typically achieved through arithmetic and logic operations with a fixed word length, cryptographic tasks or the “variable length coding” used in video compression, for example, are bit-oriented operations, that is to say where operations determined using particular bits from a data stream are to be performed but arithmetic operations are scarcely performed using constant word lengths, or transport formatting involves filtering out very specific bits or bit patterns from a data stream.

High processing powers can be achieved with hardware tailored specifically to the respective task or application (“ASHW”—Application Specific Hardware), said hardware normally being integrated into ASICs (Application Specific Integrated Circuits). Such ASHW is convincing on account of its high processing power, but is not very flexible (because it is tailored precisely to those tasks which it needs to carry out, but has little or no suitability for other kinds of tasks). In addition, ASHW blocks carry a high risk, because if the chip design of an ASIC should contain an error, which could still occur even in the case of the highly developed options used today for chip design and when simulating the operation of the chip even before the final release of the chip design for production, then an entire batch of chips may become rejects, which results in considerable financial loss.

By contrast, reconfigurable hardware allows high processing power without at the same time loosing the flexibility to be able to change its functionality following physical production of the hardware. In this case, the functionality of the reconfigurable hardware is defined such that configuration data are loaded into static RAM cells in the reconfigurable hardware, which then control the behavior of the reconfigurable hardware overall. Dynamic loading of various configuration data means that it is in some cases possible to change the functionality of the reconfigurable hardware during operation without having to interrupt the data processing to do so.

As an alternative to configuration using static RAM cells, it would also be possible to use solutions using antifuse or flash technology or else configurations defined by the metal mask.

To increase the flexibility of the hardware overall still further, the reconfigurable hardware can be coupled to a conventional processor (CPU—Central Processing Unit). Simple but nevertheless processing-intensive tasks of an algorithm can then be farmed out from the CPU, for example (which can be used for other tasks in this time). It is thus possible to improve the processing power of the hardware overall further.

With reconfigurable hardware, a distinction is drawn between “coarse-grained hardware structures” and “fine-grained hardware structures”.

Coarse-grained (CG) hardware structures are understood to mean one-dimensional or two-dimensional networks of clearly delimited arithmetic operation blocks (e.g. ALUs—Arithmetic Logical Units; MACs—Multiplier Accumulator; Adder) which are connected to one another by means of an intercommunication network. These coarse-grained hardware structures are relatively small when considered in physical terms (that is to say with respect to the required area of silicon) and perform their operations quickly. However, they are inflexible in terms of their functionality, in comparison with fine-grained structures, and normally require operands with a constant word length (nowadays typically word lengths of 32 bits). Bit-oriented operations are generally associated with a high level of processing complexity when using such coarse-grained hardware structures and are therefore not optimum.

Fine-grained (FG) hardware structures, as are typical of FPGAs (Field Programmable Gate Arrays), can be used to achieve an extremely large number of different functionalities. Fine-grained structures typically comprise a large number of small or very small logic blocks—which in some cases also contain LUTs (Look Up Tables)—which are connected by regular and very flexible connections (interconnects). Programming allows these logic blocks in connections to be configured for a particular task in the desired manner. FPGAs also have drawbacks, however. Thus, FPGAs take up a relatively large amount of space when considered in physical terms (in respect of the required area of silicon). They require a large amount of memory in order to store the necessary configuration data (because, where possible, every single function block needs to be able to be linked arbitrarily to each other function block, of course). Particularly in cases in which the reconfiguration needs to be carried out (dynamically) during operation, that is to say where the time required for reconfiguring the FPGA needs to be kept very short, large volumes of reconfiguration data should be avoided, however. In addition, it should be mentioned that although arithmetic operations can be performed using FG structures, in principle, they are much slower, particularly with larger operands (as in the case of the aforementioned operands with a word length of 32 bits, for example), than the previously discussed coarse-grained hardware structures, caused by the necessary sequential linking of small logic blocks and the resultant long signal paths. The execution time for such operations is thus significantly longer than for CG structures with the same functionality. As an alternative to FPGA-like structures, it is also possible for FG structures to be in the form of functional units for bit operations, for example, which are produced permanently, i.e. in non-reconfigurable fashion, in hardware.

As already mentioned, consequences have been drawn from the advantages and drawbacks discussed above, and hence there are already “system on chip” solutions in existence which involve a RISC CPU (Reduced Instruction Set Computer CPU) being connected to a mixed-grained reconfigurable hardware unit, an RFU (Reconfigurable Functional Unit), on a single chip. In this case, the RFU comprises a reconfigurable network RN which connects programmable function blocks with various granularity to one another. These function blocks are firstly rapid, physically compact, coarse-grained blocks and secondly highly flexible fine-grained blocks suitable for bit-oriented applications (as are typical of FPGAs, for example). Such chips allow the CPU to farm out processing operations to the RFU for whose execution the CPU would require more time than the RFU, or alternatively the CPU can undertake other tasks in this time instead of executing these processing operations.

In this case, the control of the flow of the operations to be performed is fundamentally subject to the RISC CPU's control unit, which determines the order of the operations which are to be performed (as a whole). The control unit is thus the pilot unit for the processor, which uses a program to control the data processing in the function blocks (regardless of whether these are function blocks of the CPU or of the RFU). The control unit in a CPU typically comprises a program counter and a decoder. When executing a program step, the command corresponding to the present value of the program counter is fetched from an instruction memory and is decoded by the decoder, so that the function blocks corresponding to the command and the corresponding registers can be addressed. The control unit in the CPU is therefore consequently called the FD (Fetch Decode) control unit. The individual operations can in principle be executed by the function blocks within the CPU or can be farmed out to the RFU.

If operations are farmed out to the RFU, the control unit transfers a control word to the RFU which stipulates which of the function blocks in the RFU are to perform which operations using which operands. These operations are then normally executed much more quickly by the function blocks in the RFU (ALUs, MACs, FG, etc.), and also the executing resources of the CPU are free for other operations in this time.

For many of today's applications (particularly the aforementioned multimedia applications, for example), the conventional execution of an algorithm with a single CPU is too slow. To increase the speed at which the algorithm is executed, it is now common practice to execute a plurality of steps or whole portions of an algorithm in parallel. By way of example, EP-A-1 148 414 has proposed executing a plurality of portions (“threads”) of an algorithm in parallel, with the algorithm's “threads” executed in parallel being executed by a corresponding number of similar CPUs. Alternatively, in principle all of the existing function blocks can in this case be used by any CPU control units which execute the individual steps in the respective “threads” in parallel. However, this means that it is always necessary to assign what function blocks are used by what control unit in what way. This can be done using various criteria, for example it is possible to take priorities for particular portions of the algorithm into account when assigning the function blocks, or the respective present availability of the individual function blocks can be taken into account in the assignment.

However, the control units in CPUs operate on the basis of the principle already described above (“fetch decode”, see above). However, particularly operations such as encryption/decryption, compression/decompression, signal processing, filtering or “framing” often involve small, but often repeated, processing-intensive program loops which simultaneously require relatively low control complexity. The complete execution of such tasks of the control of the FD control unit in the CPU is therefore below optimum.

### SUMMARY

This is the starting point of the present invention in that it is intended to propose a processor which is intended to execute a large number of different operations much more efficiently when executing an algorithm than is possible through the provision of a plurality of conventional CPUs.

In particular, the invention thus proposes that the processor has a plurality of control units, and also a plurality of function blocks which can be accessed by the control units jointly. A central controller defines the access by the control units to the function blocks (hardware resources). In this case, at least two control units are in the form of control units of a different type. What is to be understood by different types of control units will be explained below.

In one exemplary embodiment, this may involve at least one control unit being of the type “fetch decode”, as also occurs in conventional CPUs for example. Such a control unit typically comprises a program counter and a decoder. During operation, this control unit fetches a command corresponding to the present counterstate from an instruction memory and decodes it in the decoder. Such control units are subsequently called an FD control unit. Such an FD control unit has a large instruction set (command set) available which normally covers all of the needs of the envisaged applications (“general purpose” instruction set).

A different type of control unit operates on a basis of a different principle than a conventional FD control unit in a CPU. This control unit operating on the basis of another principle allows specific tasks to be controlled more efficiently than by an FD control unit in a conventional CPU.

Thus, in one exemplary embodiment of the inventive processor, at least one control unit may be of the type “application specific fetch decode”. Although such an application specific control unit is an FD control unit on the basis of its principle, it uses an instruction set (command set) which is tailored specifically to certain applications and is frequently greatly reduced. This instruction set—with frequently much fewer instructions compared with those which can be processed by a conventional FD control unit—can therefore be designed to be much more compact and therefore memory efficient than a “general purpose” instruction set. This control unit is therefore subsequently called the as-FD (application specific Fetch Decode) control unit. The more compact form of these instructions, i.e. a shorter word length, means that it is therefore also possible to store the entire program code locally on the chip, which allows rapid execution of the instructions without reloading from an external memory (the program code may also be fetched from an external instruction memory, however). In addition, it is possible to introduce measures, as is advantageous when filtering digital audio data, for example, which are commands such as “post increment/decrement” loop counter variables, which allow more efficient processing of the data. Furthermore, it is also possible to create specific instructions which simultaneously allow a plurality of state checks (e.g. for flags) and perform an action in accordance with the result of the check. In contrast to the conventional FD control unit, however, there are normally instructions and mechanisms missing, such as interrupt processing, which are necessary for certain applications. The omission of these components and the options of reducing the instruction word length make this type of control unit more compact in terms of the necessary chip area and more efficient in terms of processing speed for particular groups and portions of algorithms than a conventional FD control unit.

In a further exemplary embodiment of the inventive processor, at least one control unit may be of the type “application specific hardware”. This is an application specific control unit implemented in hardware. This type of control unit comprises circuits implemented specifically for an application in hardware. Such a control unit does not operate on the basis of the “fetch decode” principle, as is the case with the two control units which have already been mentioned (FD; as-FD). In this case, the flow control can be provided, by way of example, by one or more hardware-implemented FSMs (Finite State Machines), even ones which are hierarchically interleaved, which control the processing of the data on the common hardware resources for a particular algorithm. This type of control unit has the advantage that it can be constructed extremely compactly with regard to required chip area and efficiently with regard to performance, since a virtually unlimited number of events can be handled in parallel and any number of control signals can be produced in parallel. However, it is no longer possible to reprogram this control unit following production of the chip. This type of control unit is subsequently called an as-HW (application specific Hardware) control unit.

In another exemplary embodiment of the inventive processor, in turn, at least one control unit may be in the form of part of a function block with fine-grained granularity. This makes it possible to store an application specific succession of commands (macro) for a specific task either in part of the fine-grained function block permanently and to retrieve it when required, so that the application specific succession of commands is then executed, or else not to transfer an appropriate sequence of commands to the fine-grained function block in the form of configuration data at all until during execution of an algorithm so that said function block can then handle the task in question. In the text below, this type of control unit is called an r-HW (reconfigurable Hardware) control unit and differs from an as-HW control unit primarily by virtue of the fact that it is reprogrammable.

In a further exemplary embodiment of the inventive processor, a plurality of control units of different types can form a “combined control unit”. Such a combined control unit with control units of different types is advantageous over separate control units of different types inasmuch as it is possible to stipulate the best possible handling of the various steps of an algorithm actually within the combined control unit, and this requires no or little communication to take place between separate control units. By way of example, a conventional FD control unit and an as-FD control unit and also a control unit implemented in fine-grained hardware (as-HW control unit, r-HW control unit) can share the tasks which arise. In this context, by way of example, the conventional FD control unit could start to process a data stream and could farm out certain parts of the processing as a macro operation to the specialized control unit (as-HW control unit), with the former being able to perform further operations in the meantime. The control unit implemented in the fine-grained hardware generates addresses during this time, for example, in order to be able to access data in the data store.

Examples of other types of control units are combinations of the aforementioned control unit types, permanently implemented or configurable control units which are configured by antifuse programming following production, or circuits whose functionality is first defined by the metal mask in the production process.

In a further exemplary embodiment of the inventive processor, an FD control unit can be permanently assigned resources such as a register file and execution units for exclusive use, which jointly results in the fundamental elements of the CPU. Subsequently, the same FD control unit can have access to a reconfigurable hardware unit RFU. The RFU can therefore be used to extend an instruction set or else in order to execute macro operations, under the control of a further control unit. In this case, the FD control unit may be available for other tasks in this time.

The access operations by the various control units to the function blocks in the RFU are controlled by a CCU (Central Control Unit), a central controller. Control lines to all function blocks in the RFU and to the connected control units define the operations in the current operating cycle (clock cycle). The CCU thus appears more or less as a representative of one or more control units or one or more combined control units to the function blocks in the RFU.

The CCU controls the distribution of the function blocks in the RFU over the active control units and combined control units. In the event of conflicts, the distribution of the function blocks can be cancelled in various ways. By way of example, the programmer of the system can determine what control unit is to be assigned what resource (function block) at what time.

As a result of the control of a reconfigurable network which connects all of the components of the RFU and the connected control units, the CCU controls the data transfer between the function blocks in the RFU, the connected control units and external interfaces. Using these interfaces, the CCU can release, by way of example, memory blocks in the RFU for external DMA or for another processor system in order to receive or provide data directly. Control signals regulate the transfer of the results to the external components and the control units, and in the event of delays in the calculations on the RFU the appropriate control units or external circuits are stopped.

Accordingly, the reconfigurable hardware unit RFU may comprise at least one memory block which is designed such that during an operating cycle it is possible to read data to or from the memory block. It is thus possible to read data to or from the memory block during an operating cycle, for example, using DMA (see above). During an operating cycle, it is also possible to read data from the memory block and, when the data have been read, to write the next data to the memory block again during the same operating cycle.

Finally, the reconfigurable hardware unit may comprise at least one function block whose output has an output register provided at it which is in a form such that the data at the output of the function block (e.g. ALU, MAC, ADD) can optionally either be stored in the output register or be forwarded directly. This type of output register means that it is possible to buffer-store the result of an operation or to forward it directly (“bypass”) and to write it to another register again (e.g. to that of a CPU acting as a control unit). With such an output register, it is possible for the data to be read from an output register, processed in a function block and then written back to a register in a single operating cycle, for example. This allows the RFU to be used more or less as an instruction set extension in a processor, without losing any clock cycles in the process, however.

### BRIEF DESCRIPTION OF THE DRAWINGS

Further advantages can be found in the description below of exemplary embodiments of the invention with reference to the drawing, in which:

FIG. 1 shows a block diagram to explain the basic functional design of an exemplary embodiment of the inventive processor;

FIG. 2 shows the block diagram from FIG. 1, with a control unit being in the form of a CPU;

FIG. 3 shows the block diagram from FIG. 1, with a plurality of control units forming a combined control unit;

FIG. 4 shows an exemplary embodiment of a reconfigurable hardware unit in the inventive processor;

FIG. 5 shows a further exemplary embodiment of the inventive processor;

FIG. 6 shows a further exemplary embodiment of the inventive processor with an explanation of a specific application; and

FIG. 7 shows an exemplary embodiment of an output register at the output of a coarse-grained function block in the reconfigurable hardware unit.

### DETAILED DESCRIPTION

In the exemplary embodiment of the inventive processor which is shown in FIG. 1, it is possible to see a plurality of control units CU1, . . . , CUN which are firstly connected to third components (as indicated by arrows above the respective control unit) and are secondly connected to a central control unit CCU, as indicated by a double-headed arrow below the respective control unit. The central control unit CCU, for its part, is connected to a reconfigurable hardware unit RFU (Reconfigurable Functional Unit), which is likewise indicated by a double-headed arrow. In this context, the arrow tips respectively show the direction in which a flow of information can take place.

The individual control units CU1, . . . , CUN may all be of a different type, but at least two control units are of a different type. The meaning intended for the labels “of a different type” in this context is already explained in detail further above. The control units may thus be of the type FD, as-FD, as-HW or r-HW, for example, specifically in any combinations in principle.

During the course of execution of the tasks of an algorithm, the individual tasks can be transferred to the various control units CU1, . . . , CUN, which can then access the hardware resources of the RFU under the control of the central controller CCU. In this case, the hardware resources of the RFU may, in principle, be used by all control units CU1, . . . , CUN, which is why they are “common” hardware resources. The central controller CCU may in this case additionally be connected to external interfaces, which is indicated by arrows arranged at the side, for example in order to allow the interfaces to be used during an operating cycle (clock cycle) to write data to memory blocks in the RFU which are not currently being used by the control units.

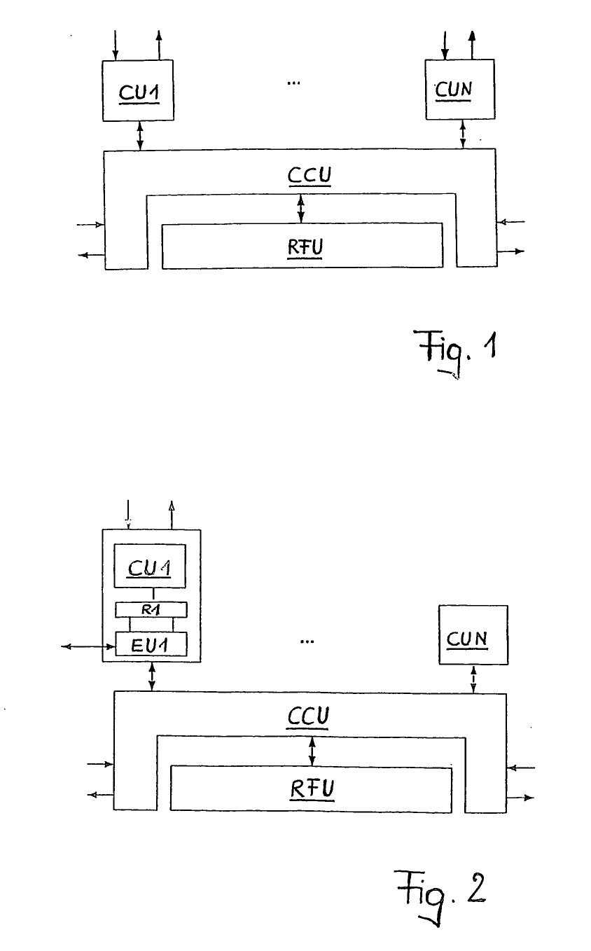

In FIG. 2 it is possible to see an exemplary embodiment of the processor in a block diagram similar to that in FIG. 1, but in this case the control unit CU1 is part of a conventional CPU because apart from the control unit CU1 the CPU also contains a register file R1, comprising one or more registers, and also execution units EU1. A control unit CU1, a register file R1 and also execution units EU1 together form the fundamental parts of a conventional CPU, however.

FIG. 3 again shows a similar block diagram to that in FIG. 1 and FIG. 2, but in this case the control units CU1, . . . , CUN form a combined control unit COMCU. In principle, just two control units can form a combined control unit, and not all control units CU1, . . . , CUN have to form a combined control unit. It is also possible for a plurality of combined control units (COMCUs) to be formed from the available control units simultaneously. Such a combined control unit COMCU with control units of different types is advantageous over separate control units of different types inasmuch as the best possible execution of the various steps of an algorithm can be stipulated within the actual combined control unit and this requires no or just a little “external” communication between separate control units. Thus, by way of example, a conventional FD control unit and an as-FD control unit and also a control unit implemented in the fine-grained hardware (as-HW control unit, r-HW control unit) can share the tasks which arise. In this context, the conventional FD control unit could start to process a data stream, for example, and farm out certain parts of the processing as a macro operation to the specialized control unit (as-HW control unit), with the former being able to execute further operations in the interim. During this time, the control unit implemented in the fine-grained hardware generates addresses, for example, in order to be able to access data in the data store. This is merely intended to serve as an example of how such combined control units can operate in particularly efficient fashion.

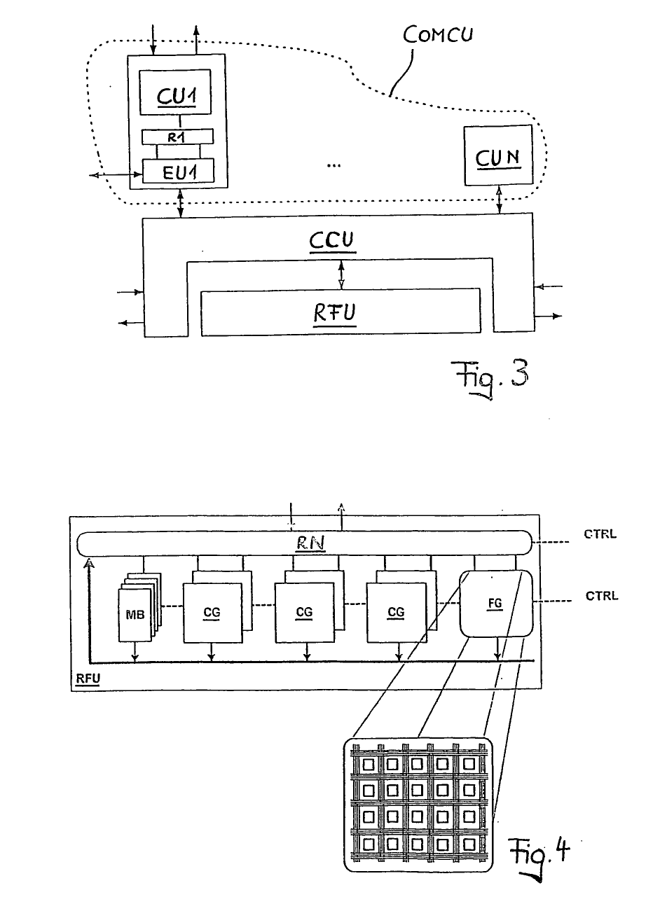

In FIG. 4 it is possible to see an exemplary embodiment of the reconfigurable hardware unit RFU in a somewhat more detailed block diagram. The RFU comprises a plurality of function blocks MB, CG, FG and also a reconfigurable network RN which connects the individual function blocks to one another and also connects the RFU to the central controller CCU (not shown in FIG. 4). The connection to the CCU is indicated by the two arrows at the top end of the reconfigurable network RN, which is intended to indicate that information can be interchanged bidirectional, that is to say in both directions. In addition, it can also be seen in FIG. 4 that both the individual function blocks MB, CG, FG and the reconfigurable network RN are controlled by the central controller CCU (not shown here), which is indicated by the dashed lines CTRL. Since the hardware unit RFU is reconfigurable, its function can be changed during operation, that is to say dynamically. This is done using the CCU, which uses appropriate configuration data to stipulate the respective functionality of the RFU at any time.

The individual function blocks of the RFU from FIG. 4 can be specified in even greater detail in terms of a function or in terms of their granularity. Thus, the function blocks MB are memory blocks, while the function blocks CG have been provided with their label for the reason that they have a course-grained structure. In particular, they conceal execution units such as ALUs, MACs, ADDs and so on (see further above), for example, whose advantages have already been described in the introduction. The function block FG—FIG. 4 shows only one such function block FG, but it is also possible for there to be a plurality of such function blocks FG—denotes a function block with a fine-grained structure. The advantages of such fine-grained function blocks FG have also already been described in the introduction, and FIG. 4 shows an exemplary embodiment of such a fine-grained function block FG in the form of FPGA-like structures (Field Programmable Gate Array).

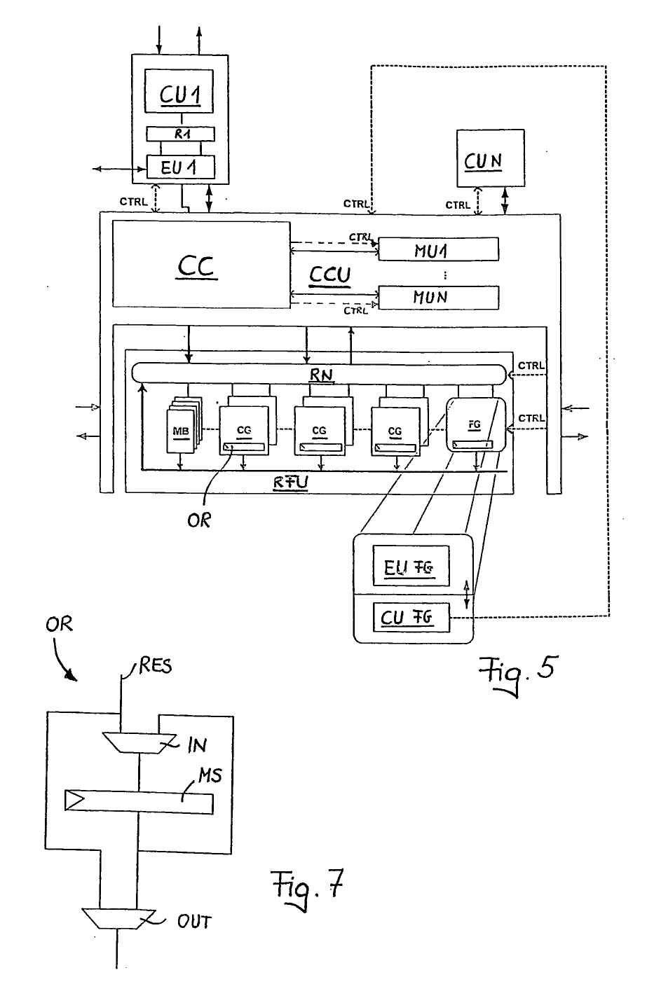

In FIG. 5 it is possible to see a further exemplary embodiment of an inventive processor. The control units CU1, . . . , CUN can again be seen, with the control unit CU1 being in the form of a conventional CPU again in this case. In addition, FIG. 5 reveals particularly clearly that a part of the fine-grained function block FG in the RFU can likewise act as a control unit. This can be controlled (even dynamically) using the configuration data from the RFU, for example. In this context, the fine-grained function block FG may again be in a similar form to an FPGA, and one part of the FG function block may act as an execution unit EUFG in this case, while another part of the FG function block acts as a control unit CUFG. The control unit CUFG also has a communicative connection to the central controller CCU, which ultimately stipulates the allocation of the RFU's resources. For the sake of better clarity, FIG. 5 shows all of the communication paths used for communicating control signals in dashed form.

Using the CCU, data can be transferred to the memory blocks MB in the RFU, for example, via external interfaces, specifically this can even take place within an operating clock cycle of the control units. While particular operations are thus executed within an operating cycle within the RFU, data which are required for subsequent operations, for example, can be written via external interfaces or by means of DMA simply to memory blocks MB which are not currently required, which means that these data are already available for the processing steps in the next operating cycle and a further operating cycle is not required in order to write these data to the memory blocks in the first place.

FIG. 5 also reveals memory units MU1, . . . , MUN which are associated with the central controller CCU. The memory units MU1, . . . , MUN contain the configuration data which define which operations are executed in the execution units and how to connect data and communication paths in the reconfigurable network RN. It is possible to assign each element which is to be configured in the RFU a dedicated memory unit MU, or else to store the configuration data for a plurality of elements which are to be configured in one memory unit MU.

In a further exemplary embodiment, the memory units MU and also the instruction memory from FD control units can be combined in a single physical memory block. This makes it possible to store either more configuration data or a larger program for the FD control unit in the memory block.

The configuration data stored in the memory units MU are applied to the RFU by the central controller CC, on the basis of control signals from the control units CU, and accordingly the functionality of the execution units (MB, CG, FG) and of the reconfigurable network RN in the RFU is influenced.

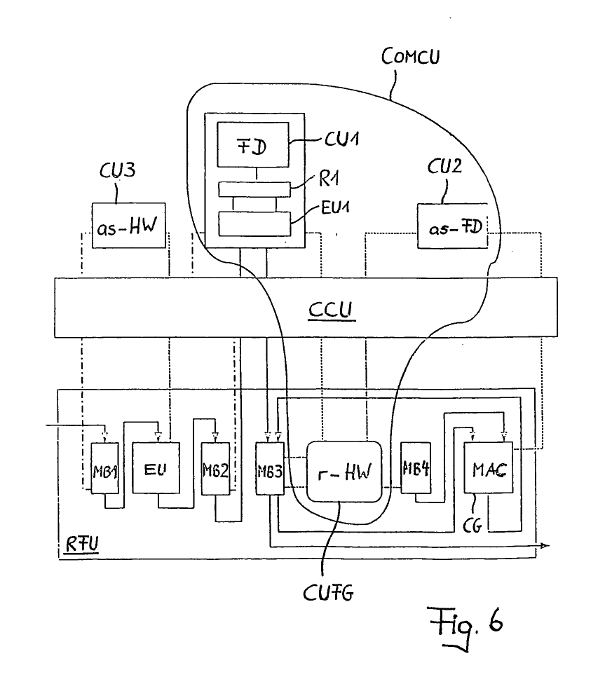

In the case of the exemplary embodiment shown in FIG. 6, it is again possible to see the control unit CU1 to which the register file R1 and the execution units EU1, which together form a conventional CPU again. In this arrangement, the control unit CU1 is a control unit of the type FD (“Fetch Decode”, see further above). In addition, it is possible to see the control unit CU2, which is of the type as-FD (“application specific Fetch Decode”, see further above), and also a further control unit CUFG of the type r-HW (“reconfigurable Hardware”), which is part of a fine-grained function block, e.g. an FPGA (see also FIG. 5). These three control units form a combined control unit COMCU. Finally, it is possible to see a further control unit CU3 of the type as-HW (“application specific Hardware”, see further above). Finally, it is also possible to see the reconfigurable hardware unit RFU with a plurality of function blocks, which is discussed further below.

The manner of operation may be as follows, for example: a compressed data stream is received by the memory block MB1, which operates on the basis of the FIFO (First-In-First-Out) principle, for example. As soon as the memory block MB1 receives data, this information is routed to the control unit CU3 of the type as-HW. This control unit starts to decompress the data and to store them in the memory block MB2 using execution units EU in the RFU. The control unit CU1 (FD control unit) reads a packet of data from the memory block MB2, splits the data into packet headers and user data, and stores the user data in the memory block MB3. Next, the control unit CU1 sends the control unit CU2 of the type as-FD the command, inside the combination, to process the data using a mathematical function, for example, (e.g. filtering), and fetches the next packet of data from the memory block MB2. In the meantime, the control unit CU2 (type: as-FD) starts to use a coarse-grained function block CG (e.g. of the type MAC, see further above) to process the user data with constants which are stored in the memory block MB4, and then to store them again in the memory block MN3. In the process, the control unit CUFG implemented in the fine-grained function block generates the addresses for the memory blocks MB3 and MB4. This is an example of how to imagine the operation of such a processor, with the operations described being executed simultaneously in “pipeline” form.

Returning to FIG. 5, the function blocks CG and FG there indicate, at the output, an output register OR which is shown more clearly again in FIG. 7 in the form of an exemplary embodiment of such an output register OR. It can be seen that, by way of example, the result RES of an operation which has been performed in a function block CG or FG and is then applied to the input IN of the register OR can either be written to a memory stage MS in the register OR or can be supplied directly to the output OUT of the register and can be forwarded from there still in the same operating cycle. It is thus possible either to buffer-store a result RES for an operation (memory stage MS) or to forward it directly (“bypass”) or even to hold it for a plurality of operating cycles (“hold”). In the case of holding, the stored result RES is simply read from the memory stage and is then written to the memory stage MS again. This can continue until a new result needs to be written to the memory stage MS. At that point at the latest, either the new result or the held result then needs to be written to a memory block MB or to another register. In principle, however, it is clear that the output register OR has the option of either forwarding the function block's result RES directly (“bypass”) or writing it to a memory block MS and storing it, or holding it (“hold”), there for an operating cycle.

Specific embodiments of a processor with different types of control unites for jointly used resources according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

1. A processor having a plurality of control units and also having function blocks which can be accessed by the control units jointly, and having a central controller which defines the access by the control units to the function blocks at least two control units are in the form of control units of a different type.

2. The processor as claimed in claim 1, wherein at least one control unit is a “Fetch Decode” type.

3. The processor as claimed in claim 1, wherein at least one control unit is of an “application specific Fetch Decode” type.

4. The processor as claimed in claim 1, wherein at least one control unit is of an “application specific Hardware” type.

5. The processor as claimed in claim 1, wherein at least one control unit is in the form of part of a function block with fine-grained granularity.

6. The processor as claimed in claim 1, wherein a plurality of control units of different types form a combined control unit.

7. The processor as claimed in claim 1, further including a separate reconfigurable hardware unit having function blocks(MB, CG, FG) which can be accessed by the control units jointly.

8. The processor as claimed in claim 7, wherein the reconfigurable hardware unit (RFU) comprises at least one memory block which is in a form such that during an operating cycle it is possible to read data to or from the memory block.

9. The processor as claimed in claim 8, wherein the reconfigurable hardware unit comprises at least one function block whose output has an output register (OR) provide such that the data at the output of the function block can be optionally stored in the output register (OR) or forwarded directly.
